(19) United States
(12) Patent Application Publication
(10) Pub. No.: US 2012/0050135 A1
(43) Pub. Date: Mar. 1, 2012

(54) METHOD AND APPARATUS FOR CONFIGURING A PLURALITY OF DISPLAYS INTO A SINGLE LARGE SURFACE DISPLAY

(75) Inventors: David I.J. Glen, Toronto (CA); Carrell Ray Killebrew, Bee Cave, TX (US)

(73) Assignees: ADVANCED MICRO DEVICES, INC., Sunnyvale, CA (US); ATI TECHNOLOGIES ULC, Markham (CA)

(21) Appl. No.: 12/870,157

(22) Filed: Aug. 27, 2010

(51) Int. Cl. G09G 5/00

(52) U.S. Cl. 345/1.1

(57) ABSTRACT

An apparatus includes a display location sensor based mapping circuit. The display location sensor based mapping circuit maps multiple displays to collectively display a single large surface in response to sensed location information from at least one of the displays.

### FIELD OF THE DISCLOSURE

The present disclosure generally relates to systems having multiple displays, and more particularly, configuring the multiple displays to collectively present a single image.

### BACKGROUND OF THE DISCLOSURE

Various applications, such as gaming applications, may use multiple displays to increase the area over which visual information may be displayed. That is, a group of displays may be arranged to form a single large surface that can display a large image partitioned across the multiple displays. The ability to drive multiple displays is beginning to allow a number of new display combinations. Such existing combinations include any combination of “cloned” displays, where more than one display shows the same desktop, and extended displays, where each display contains a different desktop. Other modes are also enabled by the driving of multiple displays, such as modes sometimes called “Very Large Desktop” (VLD), and Stretch mode or Span Mode. VLD for example, allows two or more displays to display different areas of a single desktop, and may utilize two or more GPUs coupled to the rendering ability of one GPU to drive the two or more displays (i.e. 4, 6, 8 or more). Stretch or Span Mode allows two displays to display different areas of a single desktop using a single GPU.

When a display is cloned (i.e., duplicated) there is no need to physically arrange the displays as both displays show the same image. When multiple displays are in an extended mode they can be arranged via a control panel to virtually place the desktops relative to one another. For the simpler Span Mode and Stretch Mode solutions it is relatively easy for a user to arrange the physical location of the display, or configure the software to swap the relative positions of the display, because there were only two displays involved. With VLD modes, the end user is often required and responsible for physically repositioning the physical displays (or changing the display connections) to achieve the correct display arrangement. This is an inconvenient and time consuming problem. If multiple displays are associated with a single desktop, and as the number of displays and the complexity of the potential arrangements increases, it becomes necessary to provide methods to assist in configuring the physical arrangement of the displays. That is, as the number of physical displays being used in concert increases to three or more displays, the number of combinations that can occur with respect to the physical arrangement of the displays increases but only one of those physical arrangements will present the desktop correctly (i.e., in a manner where the portions of the (virtual) desktop do not present a scrambled arrangement of the portions), and therefore a user needs assistance in arranging the displays.

However currently, in order to create the correct arrangement of displays, the user must physically move the displays to the proper physical position and/or change the cabling arrangement of individual displays to create the desired arrangement. In another method, disclosed in U.S. patent application Ser. No. 12/546,653, which is hereby incorporated herein by reference in its entirety, the user must manually map the displays using a graphical user interface. Both of these procedures can be currently used when setting up a plurality of displays to operate in VLD modes.

Therefore, a need exists for a method and apparatus to address, at least in part, some of the shortcomings related to the physical arrangement of a group of displays participating in a single large surface.

### BRIEF DESCRIPTION OF THE DRAWINGS

The invention will be more readily understood in view of the following description when accompanied by the below figures, wherein like reference numerals represent like elements:

FIG. 1 is an exemplary block diagram of a device having a display location sensor based mapping circuit according to the present disclosure;

FIG. 2 is an exemplary depiction of a frame buffer and multiple displays associated with the device;

FIG. 3 is an exemplary diagram of mapping information provided by the display location sensor based mapping circuit;

FIG. 4 is an exemplary block diagram of one of the multiple displays;

FIG. 5 is a flowchart depicting exemplary operations that can be performed by the display location sensor based mapping circuit;

FIG. 6 is a flowchart depicting additional exemplary operations that can be performed by the display location sensor based mapping circuit; and

FIG. 7 is a flowchart depicting additional exemplary operations that may be performed by the disclosed apparatus.

### BRIEF DESCRIPTION OF THE PREFERRED EMBODIMENT

In one example, an apparatus includes a display location sensor based mapping circuit. The display location sensor based mapping circuit maps multiple displays to collectively display a single large surface in response to sensed location information from at least one of the displays. A related method is also disclosed.

The method and apparatus, among other advantages, provides automated mapping of physical locations of multiple displays to a respective portion of an entire image frame so that a single large surface can be presented in an unscrambled manner regardless of the physical locations of the displays. Other advantages will be recognized by those of ordinary skill in the art.

In one example, the sensed location information is based on a proximity of at least one of the plurality of displays to at least another of the plurality of displays.

In one example, each of the displays include at least one sensor that provides the sensed location information. The sensor is positioned on an edge of each of the displays. In one example, the at least one sensor comprises a light sensor, a proximity sensor, and/or a continuity sensor. In one example, each of the displays comprises a light source that provides light. The sensor provides the sensed location information in response to the light. The light source comprises backlight from the display passing through an aperture on an edge of the display and/or an independent light source (e.g., a light emitting diode) positioned on an edge of the display.

In one example, the display location sensor based mapping circuit determines whether at least one edge of the displays is proximate to another of the displays based on the sensed location information. The display location sensor based mapping circuit determines a position of one or more of the displays within the single large surface based on the edge being proximate to another of the displays. The display location sensor based mapping circuit maps one or more of the displays based on the position. In one example, a device includes multiple displays and the apparatus.

In one example, a computer readable medium comprises information that when executed by a processor causes the processor to layout an integrated circuit that comprises the display location sensor based mapping circuit. In one example, the information comprises hardware description language.

As used herein, the term “circuit” or “module” can include an electronic circuit, one or more processors (e.g., shared, dedicated, or group of processors such as but not limited to microprocessors, digital signal processors, or central processing units) and memory that execute one or more software or firmware programs, combinational logic circuits, an application specific integrated circuit, and/or other suitable components that provide the described functionality. Additionally, as will be appreciated by those of ordinary skill in the art, the operation, design, and organization, of a “circuit” can be described in a hardware description language such as Verilog™, VHDL, or other suitable hardware description languages.

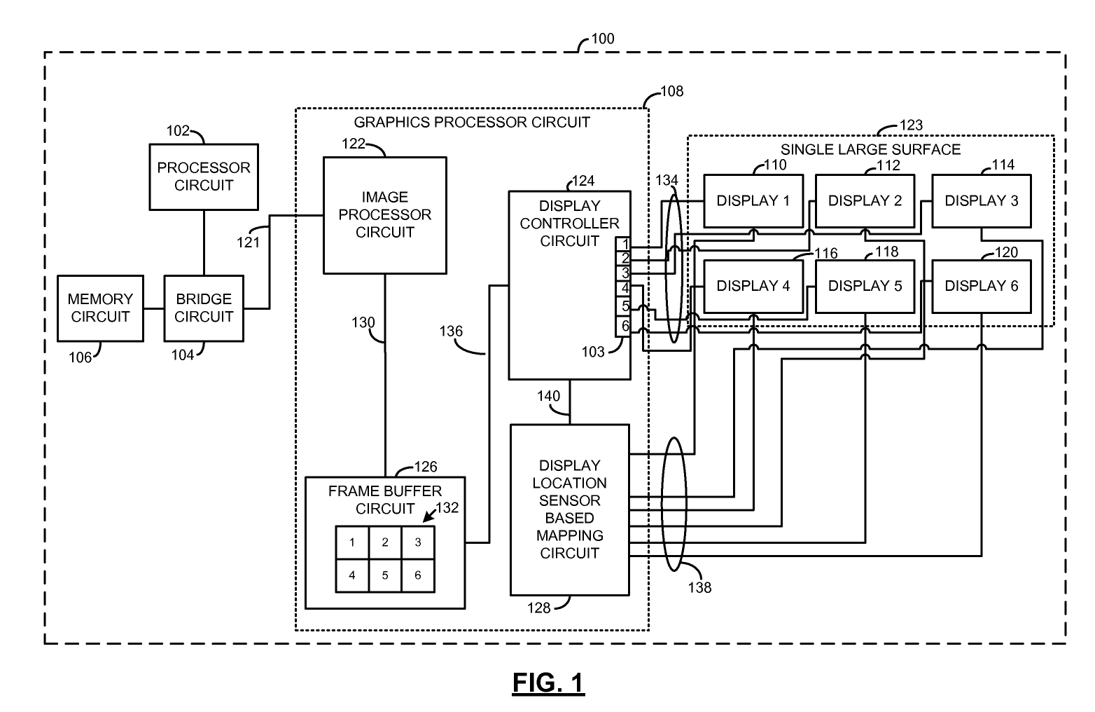

Referring now to FIG. 1, an exemplary functional block diagram of a device 100 such as a wireless phone, a mobile and/or stationary computer, a printer, a LAN interface (wireless and/or wired), a media player, a video decoder and/or encoder, and/or any other suitable device is depicted. The device 100 includes a processor circuit 102, a bridge circuit 104, a memory circuit 106, a graphics processor circuit 108, and a plurality of displays 110, 112, 114, 116, 118, 120. Although referred to as a graphics processor circuit in this example, skilled artisans will appreciate that the graphics processor circuit 108 can process video information in addition to graphics information. In addition, in some embodiments, the displays 110, 112, 114, 116, 118, 120 can be external to the device 100 if desired.

In this example, the plurality of displays 110, 112, 114, 116, 118, 120 includes six displays although more or less displays may be included if desired. As shown, in this example, the displays 110, 112, 114, 116, 118, 120 are arranged in a rectangular arrangement having three columns and two rows although other arrangements are contemplated. The displays 110, 112, 114, 116, 118, 120 are configured to collectively present an entire frame as a single large surface 123. In this example, each of the displays can present ⅙ of a frame so that the combination of all the displays 110, 112, 114, 116, 118, 120 present the entire frame as the single large surface 123.

A set of connector ports 103, which includes six connectors labeled 1 thru 6, operatively couples the display controller 124 and the displays 110, 112, 114, 116, 118, 120. The displays as illustrated, include a numerical reference number that corresponds to the connector port number of the set of connector ports 103. For example, as shown, display 1 is shown connected to port 1. Likewise, display 2 is connected to connector port 2, etc. Although, the displays 110, 112, 114, 116, 118, 120 are connected to the set of connector ports 103 via cabling in this example, the set of connector ports 103 may also be wireless. Therefore, in some embodiments, the displays 110, 112, 114, 116, 118, 120 can be wirelessly connected to a set of wireless connector ports. Further, in other embodiments, the displays 110, 112, 114, 116, 118, 120 can be connected by a combination of wired/cable and wireless connection ports. Therefore the set of connector ports 103 can, in the various embodiments, be cable type connectors, wireless connectors, or a combination of cable and wireless connectors. In still other embodiments, some, or all, displays of the plurality of displays 100 can be “daisy-chained” such that only one or two displays of a daisy-chain is connected directly to the set of connector ports 103. In the embodiments employing daisy-chained displays, the displays are still assigned a logical port number which corresponds to an initial expected position. These initial expected positions (or logical port numbers) are initially mapped to image data portions of a frame buffer as is described further below. That is, the logical port numbers may be used to create a default mapping (initial mapping or initial expected positions) of image data portions to each connected display.

The processor circuit 102 is operatively coupled to the bridge circuit 104 and processes requests from the bridge circuit 104. The memory circuit 106 stores information communicated from the bridge circuit 104. The bridge circuit 104 communicates image information 121 (e.g., drawing commands, and/or other suitable unprocessed image information) to the graphics processor circuit 108, which processes the information for presentation on the displays 110, 112, 114, 116, 118, 120.

The graphics processor circuit 108 can include an image processor circuit 122, a display controller 124, and a frame buffer circuit 126, and a display location sensor based mapping circuit 128 configured substantially as shown. The image processor circuit 122 provides processed image information 130 to the frame buffer circuit 126 in response to the image information 121. As shown, in this example, the processed image information 130 is stored as an entire image frame 132 having image frame portions (e.g., 1, 2, 3, 4, 5, 6) corresponding to each of the displays 110, 112, 114, 116, 118, 120. The display controller circuit 124 provides display information 134 in response to stored image information 136 (e.g., corresponding to the image frame 132) for presentation by the displays 110, 112, 114, 116, 118, 120.

When the displays 110, 112, 114, 116, 118, 120 are initially connected, via any suitable means, (cables, wireless ports, daisy-chaining, or combinations thereof), each display is initially mapped to an image data portion of the frame buffer circuit 126. This mapping may be considered a default mapping based simply on the physical connections of the connector ports 103. However, if the displays 110, 112, 114, 116, 118, 120 are arranged in an order that differs from the expected or default order, the image displayed by the group will appear out of order and therefore will appear scrambled.

The display location sensor based mapping circuit 128 maps the displays 110, 112, 114, 116, 118, 120 to collectively display the single large surface in response to sensed location information 138. More specifically, the display location sensor based mapping circuit 128 provides mapping information 140 to the display controller circuit 124. In response to the mapping information 140, the display controller circuit 124 can provide respective display information 134 to each of the displays 110, 112, 114, 116, 118, 120 so that image frame portion 1 of the image frame 132 corresponds to display 110, image frame portion 2 of the image frame 132 corresponds to display 112, image frame portion 3 of the image frame 132 corresponds to display 114, image frame portion 4 of the image frame 132 corresponds to display 116, image frame portion 5 of the image frame 132 corresponds to display 118, and image frame portion 6 of the image frame 132 corresponds to display 120. As such, the displays 110, 112, 114, 116, 118, 120 each display respective image frame portions (e.g., 1, 2, 3, 4, 5, 6) of the entire frame 132 to collectively present the single large surface 123 across the displays 110, 112, 114, 116, 118, 120.

The sensed information 138 can be based on a proximity of one of the displays to another of the displays. For example, in one embodiment, each display 110, 112, 114, 116, 118, 120 can include a sensor positioned on each edge of the respective display. The sensor can provide the sensed information 138 based on sensing a proximity of another display. In one embodiment, the sensed information can be communicated to the display location sensor based mapping circuit 128 via the connectors ports 103 if desired via display DDC. As discussed in more detail below, the sensor can be any suitable sensor capable of sensing another display such as a light sensor, a proximity sensor, a continuity sensor, and/or other suitable sensors.

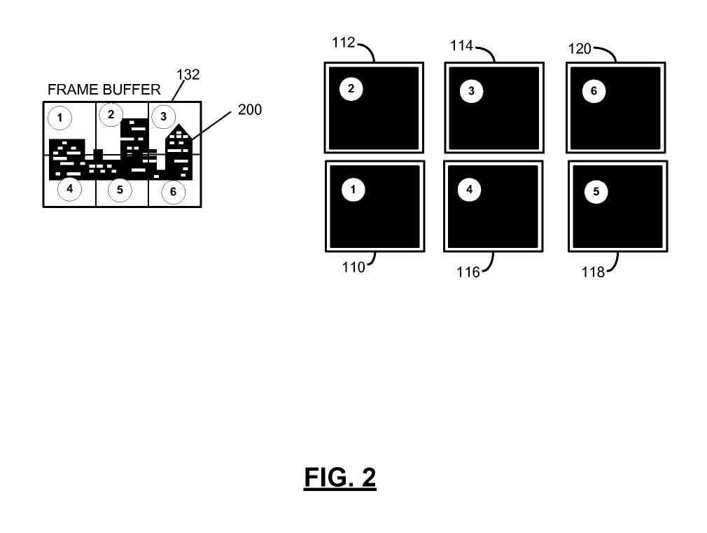

FIG. 2 depicts details of the frame buffer 132 having partitions of an exemplary image of a city skyline 200 into a set of six image data portions as shown. As shown, the displays 110, 112, 114, 116, 118, 120 are arranged in a similar rectangular arrangement. However the numerical indices shown on the displays correspond only to the physical connector ports of the plurality of connector ports 103. That is, as shown, the first row of displays consists of display 2, 3 and 6 (i.e., display 112, 114, 120, respectively). The second row of displays consists of display 1, 4 and 5 (i.e., display 110, 116, 118, respectively). However the frame buffer 132 expects to display the portion of image 200 corresponding to logical image data portion 1 on display 1. As shown, the image 200 would be chopped up and mapped to the displays, which are in a different order than the current mapping order of the frame buffer. Therefore, the image would initially appear out of order or scrambled on the displays, such as an unarranged puzzle might appear. As such, the display controller 124 must be made aware of the actual physical position of each display of the plurality of displays so that the correct portions of the image 200 may be displayed in the correct physical display positions. In other words, the logical image data portions 1 thru 6 of the frame buffer 132 must be mapped to the correct displays corresponding to their actual physical positions within the display arrangement so that the image 200 will be correctly displayed.

Referring now to FIG. 3, as noted above, the display location sensor based mapping circuit 128 provides mapping information 140 to the display controller circuit 124 in response to sensed location information 138. The sensed location information 138 is based on a proximity of at least one of the displays to at least another of the plurality of displays. More specifically, the display location sensor based mapping circuit 128 determines whether at least one edge of at least one of the displays is proximate at least another of the plurality of displays based on the sensed location information 138. As such, the display location sensor based mapping circuit 128 can determine a position of the displays within the single large surface based on the edge being proximate another of the displays. As shown, the mapping information 140 can include, among other things, a mapping of the physical display location to the image data portion. Accordingly, the display location sensor based mapping circuit 128 uses the mapping information 140 to map the displays 110, 112, 114, 116, 118, 120 to collectively display the image 200 as a single large surface in response to the sensed location information 138.

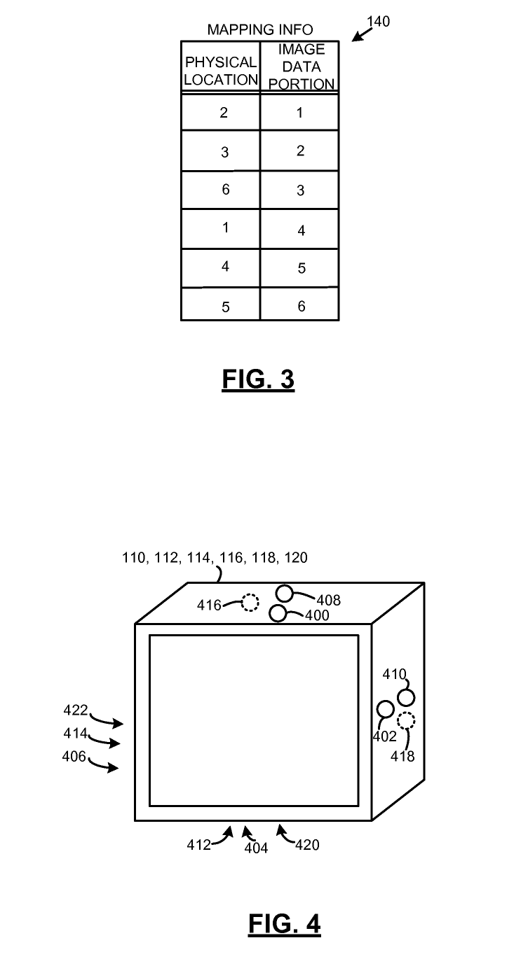

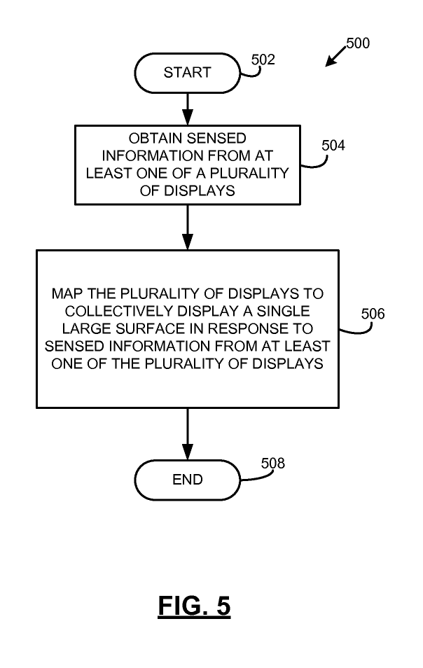

Referring now to FIG. 4, a block diagram of one of the displays 110, 112, 114, 116, 118, 120 is depicted. As previously noted, each of the displays 110, 112, 114, 116, 118, 120 have at least one sensor 400, 402, 404, 406 on each side edge. The sensors 400, 402, 404, 406 can be any suitable sensor capable of detecting the presence of another display. In one embodiment, each of the displays 110, 112, 114, 116, 118, 120 also have at least one aperture 408, 410, 412, 414 on each side edge. The apertures 408, 410, 412, 414 allow backlight from the display 110, 112, 114, 116, 118, 120 to pass through. As such, in this embodiment, the sensors 400, 402, 404, 406 are light sensors and can detect the presence of a display by detecting the backlight passed through the apertures 408, 410, 412, 414. In one embodiment, the backlight passing through the apertures 408, 410, 412, 414 can be filtered to remove visible light and to pass light which is invisible to the human eye.

In one embodiment, each of the displays 110, 112, 114, 116, 118, 120 can have at light emitting diode (LED) 416, 418, 420, 422 on each side edge instead of (or in addition to) the apertures 408, 410, 412, 414. As such, the sensors 400, 402, 404, 406 can be light sensors to detect the light from the corresponding LEDs 416, 418, 420, 422 on another display. In one embodiment, the LEDs 416, 418, 420, 422 can be infrared LEDs although other LEDs are contemplated.

In another embodiment, the sensors 400, 402, 404, 406 can be proximity sensors that are capable of detecting the presence of another display via a change in an electromagnetic field. In yet another embodiment, the sensors 400, 402, 404, 406 can be electrical continuity sensors. In this embodiment, the edge of each of the displays 110, 112, 114, 116, 118, 120 can have a male and female electrical connection. When the displays 110, 112, 114, 116, 118, 120 are arranged into a grid such as the single large surface 123 depicted in FIG. 1, the sensors 400, 402, 404, 406 detect electrical continuity to determine the presence of another display along its edge. Other sensors may be used to detect the presence of displays along the edge of a respective display.

Referring now to FIG. 5, exemplary operations that can be performed by the display location sensor based mapping circuit 128 are generally identified at 500. The process begins at 502. At 504, the display location sensor based mapping circuit 128 obtains the sensed location information 138 from one or more of the displays 110, 112, 114, 116, 118, 120. At 506, the display location sensor based mapping circuit 128 maps the displays 110, 112, 114, 116, 118, 120 to collectively display the image 200 as the single large surface 123 in response to the sensed location information 138 from one or more of the displays 110, 112, 114, 116, 118, 120. The process ends at 508.

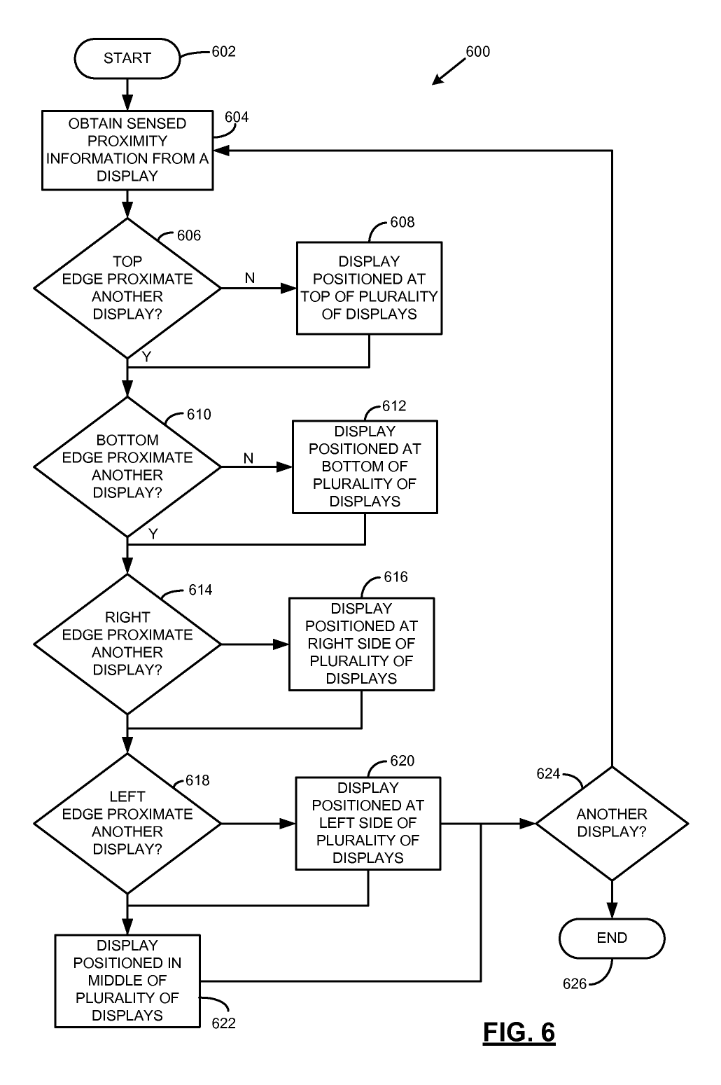

Referring now to FIG. 6, exemplary operations that can be performed by the display location sensor based mapping circuit 128 for each display 110, 112, 114, 116, 118, 120 are generally identified at 600. The process starts at 602. At 604, the display location sensor based mapping circuit 128 obtains the sensed location information 604 that indicates whether an edge of a display is proximate another display. At 606, the display location sensor based mapping circuit 128 determines whether the top edge of the respective display is proximate another display. If the top edge of the respective display is not proximate another display, the display location sensor based mapping circuit 128 determines that the respective display is positioned at the top of the plurality of displays 110, 112, 114, 116, 118, 120 at 608. However, if the top edge of the respective display is proximate another display, the display location sensor based mapping circuit 128 determines whether the bottom edge of the respective display is proximate another display at 610.

If the bottom edge of the respective display is not proximate another display, the display location sensor based mapping circuit 128 determines that the respective display is positioned at the bottom of the plurality of displays 110, 112, 114, 116, 118, 120 at 612. However, if the bottom edge of the respective display is proximate another display, the display location sensor based mapping circuit 128 determines whether the right edge of the respective display is proximate another display at 614.

If the right edge of the respective display is not proximate another display, the display location sensor based mapping circuit 128 determines that the respective display is positioned at the right side of the plurality of displays 110, 112, 114, 116, 118, 120 at 616. However, if the right edge of the respective display is proximate another display, the display location sensor based mapping circuit 128 determines whether the left edge of the respective display is proximate another display at 618.

If the left edge of the respective display is not proximate another display, the display location sensor based mapping circuit 128 determines that the respective display is positioned at the left side of the plurality of displays 110, 112, 114, 116, 118, 120 at 620. However, if the left edge of the respective display is proximate another display, the display location sensor based mapping circuit 128 determines that the respective display is positioned in the middle of the plurality of displays 110, 112, 114, 116, 118, 120 at 622.

At 624, the display location sensor based mapping circuit 128 determines whether another of the displays 110, 112, 114, 116, 118, 120 needs to be mapped. If another of the displays 110, 112, 114, 116, 118, 120 needs to be mapped, the process returns to 604. However, if all the displays 110, 112, 114, 116, 118, 120 have been mapped, the process ends at 626.

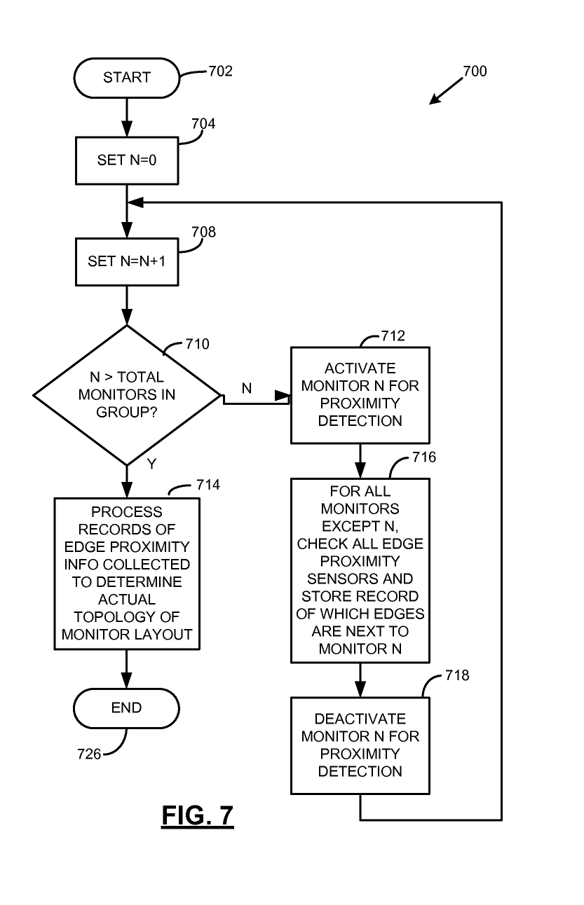

FIG. 7 illustrates another example where a display is located in the center or has neighboring displays on multiple sides of the display. As shown in block 702, the method begins and the circuit sets the number of displays initially to zero. This is shown in block 704. As shown in block 708, the method includes incrementing the set number. As shown in block 710, the method includes determining whether the current number of displays is greater than the total displays in the group. If yes, the method continues to block 714 where the method includes processing the records of edge proximity information collected to determine the actual topology of the display layout. This may be done using any sensing technique as desired. For example, the sensors for multiple sides of the displays are used to indicate that the display may be, for example, adjacent multiple displays on multiple sides.

As shown in block 712, if the total number of displays is not greater than the set number, the method includes activating display N for proximity detection. As shown in block 716, the method includes for all displays except N, checking all edge proximity sensors and store the record of which edges are next to display N, the current display. As shown in block 718, the method includes deactivating the display N for proximity detection and repeating the process for another display. The method continues until records are stored for each of the displays and their associated detected edges with respect to other displays. The mapping of the plurality of displays is done to provide an understanding of the spatial relationship amongst the differing displays so that their respective locations with respect to an overall configuration is understood by the system.

As noted above, among other advantages, the method and apparatus provide automated mapping of physical locations of multiple displays to a respective portion of an entire image frame so that a single large surface can be presented in an unscrambled manner regardless of the physical locations of the displays. Other advantages will be recognized by those of ordinary skill in the art.

Although the disclosure is described herein with reference to specific embodiments, various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure. Any benefits, advantages, or solutions to problems that are described herein with regard to specific embodiments are not intended to be construed as a critical, required, or essential feature or element of any or all the claims. In addition, unless stated otherwise, terms such as “first” and “second” are used to arbitrarily distinguish between the elements such terms describe. Thus, these terms are not necessarily intended to indicate temporal or other prioritization of such elements. The term coupled, as used herein, is defined as connected, although not necessarily directly, and not necessarily mechanically. As used herein, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. The terms a or an, as used herein, are defined as one or more than one.

What is claimed is:

1. An apparatus comprising:
a display location sensor based mapping circuit that is operative to map a plurality of displays to collectively display a single large surface in response to sensed location information from at least one of the plurality of displays.

2. The apparatus of claim 1 wherein the sensed location information is based on a proximity of at least one of the plurality of displays to at least another of the plurality of displays.

3. The apparatus of claim 1 wherein each of the plurality of displays include at least one sensor, positioned on an edge of each of the plurality of displays, that is operative to provide the sensed location information.

4. The apparatus of claim 1 wherein the display location sensor based mapping circuit is operative to determine whether at least one edge of the at least one of the plurality of displays is proximate at least another of the plurality of displays based on the sensed location information.

5. The apparatus of claim 4 wherein the display location sensor based mapping circuit is operative to determine a position of the at least one of the plurality of displays within the single large surface based on the at least one edge being proximate the at least another of the plurality of displays.

6. The apparatus of claim 5 wherein the display location sensor based mapping circuit is operative to map the at least one of the plurality of displays based on the position.

7. The apparatus of claim 3 wherein the at least one sensor comprises at least one of: a light sensor, a proximity sensor, and a continuity sensor.

8. The apparatus of claim 3 wherein each of the plurality of displays comprises a light source that is operative to provide light, wherein the at least one sensor is operative to provide the sensed location information in response to the light and wherein the light source comprises at least one of: backlight from the display passing through an aperture on an edge of the display and a light emitting diode positioned on an edge of the display.

9. The apparatus of claim 1 wherein the mapping circuit is operative to activate display proximity detection for each of a plurality of displays and determine which edges of a particular display are next to a particular display among a plurality of displays and process the stored per-display proximity detection information to determine an actual topology of a multi-display layout.

10. A method comprising:
obtaining sensed location information from at least one of a plurality of displays
mapping the plurality of displays to collectively display a single large surface in response to sensed location information from the at least one of the plurality of displays.

11. The method of claim 10 wherein the sensed location information is based on a proximity of the at least one of the plurality of displays to at least another of the plurality of displays.

12. The method of claim 10 wherein the sensed location information indicates whether a top edge, a bottom edge, a right edge, and a top edge of the at least one of the plurality of displays is proximate at least another of the plurality of displays.

13. The method of claim 10 comprising determining whether at least one edge of the at least one of the plurality of displays is proximate at least another of the plurality of displays based on the sensed location information.

14. The method of claim 13 comprising determining a position of the at least one of the plurality of displays within the single large surface based on the at least one edge being proximate the at least another of the plurality of displays.

15. The method of claim 14 comprising mapping the at least one of the plurality of displays based on the position.

16. A device comprising:
a plurality of displays; and
a display location sensor based mapping circuit that is operative to map the plurality of displays to collectively display a single large surface in response to sensed location information from at least one of the plurality of displays.

17. The device of claim 16 wherein the sensed location information is based on a proximity of at least one of the plurality of displays to at least another of the plurality of displays.

18. The device of claim 16 wherein each of the plurality of displays include at least one sensor, positioned on an edge of each of the plurality of displays, that is operative to provide the sensed location information.

19. The device of claim 16 wherein the display location sensor based mapping circuit is operative to determine whether at least one edge of the at least one of the plurality of displays is proximate at least another of the plurality of displays based on the sensed location information.

20. The device of claim 19 wherein the display location sensor based mapping circuit is operative to determine a position of the at least one of the plurality of displays within the single large surface based on the at least one edge being proximate the at least another of the plurality of displays.

21. The device of claim 20 wherein the display location sensor based mapping circuit is operative to map the at least one of the plurality of displays based on the position.

22. A computer readable medium comprising information that when executed by at least one processor causes the at least one processor to layout an integrated circuit that comprises a display location sensor based mapping circuit that is operative to map a plurality of displays to collectively display a single large surface in response to sensed location information from at least one of the plurality of displays.

23. The computer readable medium of claim 22 wherein the information comprises hardware description language.
